(19) United States
(12) Patent Application Publication
(10) Pub. No.: US 2025/0209694 A1
(43) Pub. Date: Jun. 26, 2025

(54) INFORMATION PROCESSING APPARATUS, VISUALIZATION METHOD, AND NON-TRANSITORY COMPUTER-READABLE MEDIUM

(71) Applicant: NEC Corporation, Tokyo (JP)

(72) Inventors: Masakazu HIROKAWA, Tokyo (JP); Yoshio Kameda, Tokyo (JP); Keita Sakuma, Tokyo (JP); Ryuta Matsuno, Tokyo (JP); Miyu Kashiyama, Tokyo (JP); Takayuki Itoh, Tokyo (JP)

(73) Assignee: NEC Corporation, Tokyo (JP)

(21) Appl. No.: 18/966,220

(22) Filed: Dec. 3, 2024

(30) Foreign Application Priority Data
Dec. 22, 2023 (JP) 2023-217454

(51) Int. Cl. G06T 11/20; G06N 20/20

(52) U.S. Cl. CPC G06T 11/206; G06N 20/20

(57) ABSTRACT

An information processing apparatus includes: an acquisition unit that acquires a first data set, and acquires a first composite learner including a plurality of individual learners; and an output unit that outputs first visualization information including first graphic information summarizing, in a case where the first data set is input to the first composite learner, composite output information output by the first composite learner, individual output information output by each individual learner, configuration information of each individual learner, and a relationship between different individual learners.

### INCORPORATION BY REFERENCE

This application is based upon and claims the benefit of priority from Japanese patent application No. 2023-217454, filed on Dec. 22, 2023, the disclosure of which is incorporated herein in its entirety by reference.

### TECHNICAL FIELD

The present disclosure relates to an information processing apparatus, a visualization method, and a visualization program.

### BACKGROUND ART

Japanese Unexamined Patent Application Publication No. 2022-067429 discloses a technique related to an identification result display apparatus being capable of displaying identification accuracy according to an identification target in a composite identifier that combines a plurality of identifiers. The identification result display apparatus according to Japanese Unexamined Patent Application Publication No. 2022-067429 displays an individual identification indicator indicating the identification accuracy of an identifier included in the composite identifier, and a composite identification indicator indicating the identification accuracy of the composite identifier.

### SUMMARY

However, the technique according to Japanese Unexamined Patent Application Publication No. 2022-067429 is a technique for displaying, side by side, an individual identification indicator of each of a plurality of identifiers and a composite identification indicator, and thus, there is a problem that it is difficult to comprehensively grasp characteristics of a composite identifier and an individual identifier. For example, in the technique according to Japanese Unexamined Patent Application Publication No. 2022-067429, the problem becomes evident in a case where the number of individual identifiers and a type of indicators are equal to or larger than a certain number.

In view of the problem described above, an example object of the present disclosure is to provide an information processing apparatus, a visualization method, and a visualization program for easily comprehensively visually recognizing a characteristic of a composite learner including a plurality of learner.

In a first example aspect, an information processing apparatus according to the present disclosure includes
an output means for outputting first visualization information including first graphic information summarizing, in a case where a first data set is input to a first composite learner including a plurality of individual learners, composite output information output by the first composite learner, individual output information output by each individual learner, configuration information of each individual learner, and a relationship between different individual learners.

In a second example aspect, a visualization method according to the present disclosure includes,
by a computer:
acquiring a first data set; and
outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

In a third example aspect, a visualization program according to the present disclosure causes a computer to execute:
processing of acquiring a first data set; and
processing of outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

### BRIEF DESCRIPTION OF DRAWINGS

The above and other aspects, features and advantages of the present disclosure will become more apparent from the following description of certain example embodiments if taken in conjunction with the accompanying drawings, in which:

FIG. 1 is a block diagram illustrating a configuration of an information processing apparatus according to the present disclosure;

FIG. 2 is a flowchart illustrating a flow of a visualization method according to the present disclosure;

FIG. 3 is a block diagram illustrating a configuration of a visualization system of a composite learner according to the present disclosure;

FIG. 4 is a flowchart illustrating a flow of the visualization method according to the present disclosure;

FIG. 5 is a diagram for describing visualization information according to the present disclosure;

FIG. 6 is a diagram for describing a relationship between individual learners according to the present disclosure;

FIG. 7 is a diagram illustrating a display example of detailed information of configuration information of the individual learner according to the present disclosure;

FIG. 8 is a diagram illustrating a display example of a rule adjustment screen according to the present disclosure;

FIG. 9 is a diagram illustrating a display example of a feature amount histogram of a sample included in a leaf according to the present disclosure;

FIG. 10 is a diagram illustrating a display example of a prediction error of a sample included in a leaf according to the present disclosure;

FIG. 11 is a diagram illustrating a display example of the visualization information according to the present disclosure;

FIG. 12 is a diagram for describing a difference display between data sets in the visualization information according to the present disclosure;

FIG. 13 is a diagram illustrating an example of a comparative display between different data sets in the same composite learner according to the present disclosure; and

FIG. 14 is a block diagram illustrating a hardware configuration of the information processing apparatus according to the present disclosure.

### EXAMPLE EMBODIMENT

Hereinafter, example embodiments of the present disclosure will be described in detail with reference to the drawings. In each drawing, the same or corresponding elements are denoted by the same reference signs, and redundant descriptions are omitted as necessary for clarity of description.

### First Example Embodiment

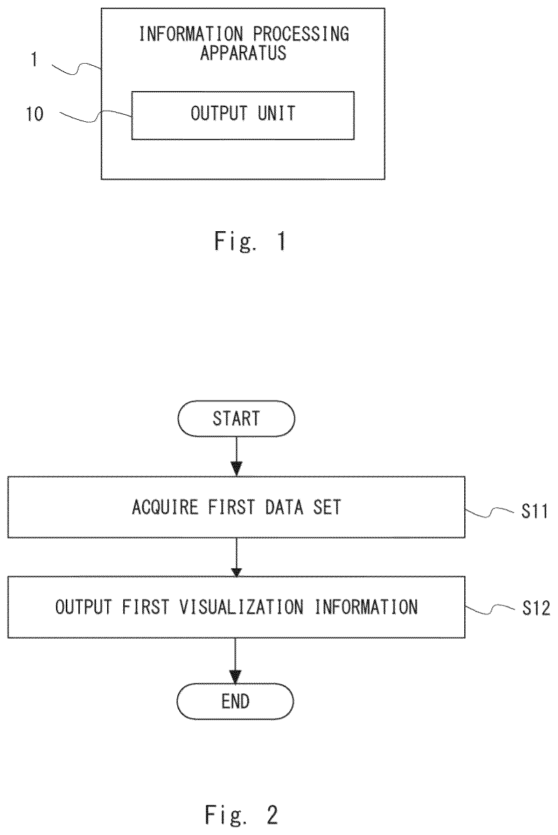

Hereinafter, a configuration of an information processing apparatus 1 will be described with reference to FIG. 1. The information processing apparatus 1 outputs visualization information including graphic information indicating a summary of a characteristic of the composite learner in a case where a predetermined data set is input to a predetermined composite learner including a plurality of individual learners.

Herein, a learner in the present specification includes a learning function for performing machine learning on a predetermined artificial intelligence (AI) model, and an AI model to be trained. The learning function includes a computer program in which predetermined machine learning algorithm is implemented, and a hyper parameter such as a setting value. In the AI model, a feature vector being multi-dimensional data is input, and an estimated value is output from the input data. Alternatively, the AI model may output a “result of classifying input data into a predetermined category or label”. For example, the AI model used in the present disclosure is applicable to a problem of deriving an estimated value from input data in a state where a correct answer with respect to the input data exists. Therefore, in the AI model used in the present disclosure, a parameter can be performed machine learning by supervised learning. Note that, in the following description, the AI model may be simply referred to as a “model”.

Further, an “individual learner” refers to a single unit of the above-described learner. Then, a “composite learner” includes a plurality of the individual learners. Note that, some or all of the learning function and the model may be different for each of the plurality of individual learners. In other words, the composite learner may include a plurality of individual learners different from each other. The composite learner includes a plurality of individual learners, and a learning function for causing a model of each individual learner to perform machine learning. The learning function of the composite learner inputs input data set to each individual learner, and acquires output information from each individual learner. Note that, information to be input to the individual learner may be information being output from another individual learner, in addition to the data set, or in place of the data set itself. In other words, the learning function of the composite learner may input the input data set to some or all of the individual learners among the plurality of individual learners, and acquire the output information from some or all of the individual learners. The learning function of the composite learner may include a computer program in which predetermined machine learning algorithm is implemented, and a hyper parameter such as a setting value. Note that, the composite learner may include a model in which each model of the plurality of individual learners is integrated. Note that, the predetermined composite learner may be referred to as a first composite learner. Further, the predetermined data set may be referred to as a first data set.

Further, the information processing apparatus 1 includes at least an output unit 10. The output unit 10 outputs first visualization information including first graphic information summarizing, in a case where the first data set is input to the first composite learner, various types of information related to the first composite learner and each individual learner. Herein, the various types of information include composite output information output by the first composite learner, individual output information output by each individual learner, configuration information of each individual learner, and a relationship between different individual learners. Herein, the composite output information is information output by the first composite learner in a case where the first data set is input to the first composite learner. Further, the individual output information is information output by the individual learner in a case where the first data set is input from the first composite learner to the individual learner. Further, the configuration information of the individual learner is information indicating a configuration of a trained model in a case where the first data set is input from the first composite learner to the individual learner. Alternatively, the configuration information of the individual learner may be information indicating a configuration of a model utilized at a time of input of the first data set in a case where the model has been trained. Alternatively, the configuration information of the individual learner may be information indicating a configuration of the model due to re-training of the model according to a change of the first data set or the hyper parameter. Further, the relationship between different individual learners is information indicating commonality or difference of the configuration information and the individual output information among two or more individual learners included in the first composite learner.

Further, it can be said that processing of “summarizing the composite output information, the individual output information, the configuration information of each individual learner, and the relationship between the different individual learners” is processing of omitting, aggregating, integrating, and the like with respect to some of these four or more types of information, and converting them into graphic information. Further, the summarizing processing may be processing of compressing an amount of information into graphic information being capable of visually recognizing by a user from a large number of types of or a large amount of numerical information or the like. Further, the summarizing processing may be processing of converting four or more types of information into information on a low-dimensional space such as three dimensions. Note that, these pieces of summarizing processing are merely examples, and are not limited thereto. For example, these pieces of summarizing processing may be processing of converting at least one or more pieces of information including the “relationship between different individual learners” among four or more types of information into graphic information acquired by aggregating or the like the pieces of information. In other words, the output unit 10 may summarize, by aggregating or the like, one or more pieces of information including at least the “relationship between different individual learners” among the four or more types of information, and convert the summarized information into graphic information.

Herein, the information processing apparatus 1 may acquire a data set for input and a first composite learner to be visualized. Therefore, it can be said that the information processing apparatus 1 includes an acquisition unit that acquires the data set and the first composite learner.

The information processing apparatus 1 generates first graphic information summarizing, in a case where the first data set is input to the first composite learner, the composite output information, the individual output information of each individual learner, the configuration information of each individual learner, and the relationship between the different individual learners. Note that, the information processing apparatus 1 may generate first graphic information summarizing, in a case where the first data set is input to the first composite learner, one or more pieces of information including at least the relationship between the different individual learners. Then, the information processing apparatus 1 generates first visualization information including the generated first graphic information. Therefore, it can be said that the information processing apparatus 1 includes a generation unit that generates the first graphic information, and generates the first visualization information including the generated first graphic information.

Then, the information processing apparatus 1 outputs the generated first visualization information to a display apparatus. The display apparatus displays the first visualization information on a screen. Note that, the display apparatus may be any of a display apparatus built in the information processing apparatus 1, and an external apparatus connected to the information processing apparatus 1.

Note that, the above-described acquisition unit may be used as a means for acquiring information or data. Further, the above-described generation unit may be used as a means for generating information or data. Furthermore, the output unit 10 may be used as a means for outputting information or data.

Next, a flow of a visualization method will be described by using FIG. 2. First, the information processing apparatus 1 acquires a first data set (S11). In addition, the information processing apparatus 1 may acquire a first composite learner to be visualized. Note that, the first composite learner to be visualized may be set in advance in the information processing apparatus 1. Subsequently, the information processing apparatus 1 generates first graphic information summarizing, in a case where the first data set is input to the first composite learner, composite output information, individual output information, configuration information of each individual learner, and a relationship between different individual learners. Then, the information processing apparatus 1 outputs first visualization information including the generated first graphic information (S12). As a result, a display apparatus displays the visualization information on a screen. Therefore, a user can visually recognize the visualization information displayed on the display apparatus.

In this way, the information processing apparatus 1 outputs visualization information acquired by graphically converting a characteristic of the composite learner with respect to a specific data set. In particular, the information processing apparatus 1 includes, in the visualization information, first graphic information summarizing composite output information, individual output information, configuration information of each individual learner, and a relationship between different individual learners. Therefore, a user can easily comprehensively visually recognize a characteristic of the composite learner including the plurality of learners by the visualization information.

Note that, the information processing apparatus 1 includes a processor, a memory, and a storage apparatus as a not-illustrated configuration. Further, the storage apparatus stores, for example, a computer program in which processing of the visualization method in FIG. 2 is implemented. Then, the processor reads a computer program or the like from the storage apparatus into the memory, and executes the read computer program. As a result, the processor achieves a function of the (acquisition unit, generation unit, and) output unit 10.

Alternatively, each of constituent elements of the information processing apparatus 1 may be achieved by dedicated hardware. Further, some or all of the constituent elements of each apparatus may be achieved by general-purpose or dedicated circuitry, a processor, or the like, or a combination thereof. These may be constituted by a single chip, or may be constituted by a plurality of chips connected via a bus. Some or all of the constituent elements of each apparatus may be achieved by a combination of the above-described circuitry or the like and a program. Further, as the processor, a central processing unit (CPU), a graphics processing unit (GPU), a field-programmable gate array (FPGA), a quantum processor (quantum computer controlled chip), and the like can be used.

Further, in a case where some or all of the constituent elements of the information processing apparatus 1 are achieved by a plurality of information processing apparatuses, pieces of circuitry, or the like, the plurality of information processing apparatuses, pieces of circuitry, or the like may be centrally arranged, or may be distributedly arranged. For example, the information processing apparatus, the circuitry, or the like may be achieved as a form, such as a client server system, or a cloud computing system, of connecting to each other via a communication network. Further, the function of the information processing apparatus 1 may be provided in a software as a service (SaaS) form.

### Second Example Embodiment

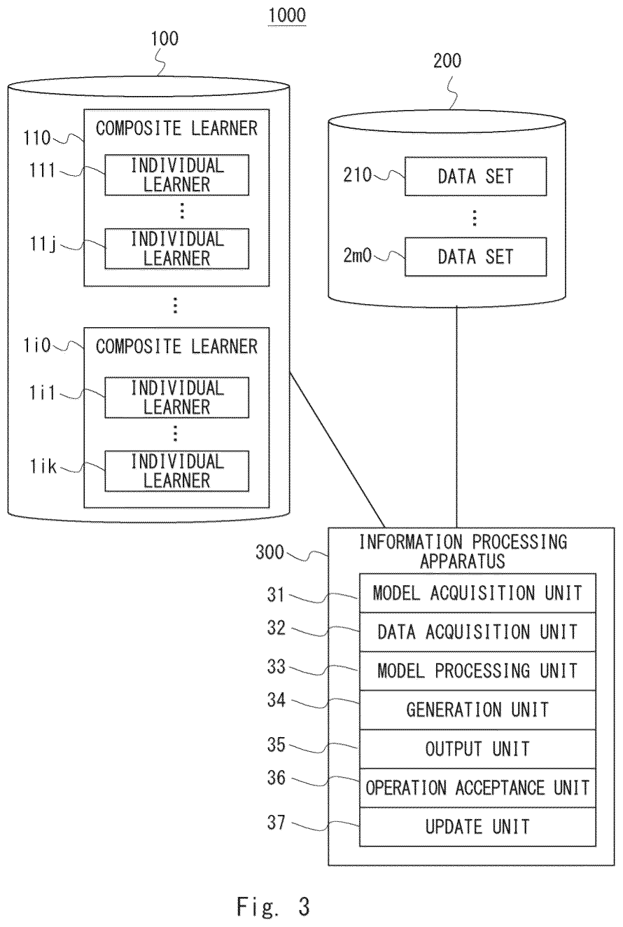

Subsequently, a configuration of a visualization system 1000 of a composite learner will be described with reference to FIG. 3. The visualization system 1000 includes at least storage apparatuses 100 and 200, and an information processing apparatus 300. Each of the storage apparatuses 100 and 200 and the information processing apparatus 300 is communicably connected to each other via a communication network (not illustrated). Note that, the communication network is a wired or wireless communication line. Alternatively, the information processing apparatus 300 may incorporate one or both of the storage apparatuses 100 and 200. Further, the storage apparatuses 100 and 200 may be achieved by being distributed among a plurality of storages. Alternatively, the storage apparatuses 100 and 200 may be built in a server in a predetermined information system. Note that, each of the storage apparatuses 100 and 200 is, for example, a non-volatile storage apparatus such as a hard disk and a flash memory.

The storage apparatus 100 stores composite learners 110 to 110 (i is a natural number equal to or greater than 1). Each of the composite learner 110 and the like is one example of first and second composite learners. For example, the composite learner 110 includes individual learners 111 to 11j (j is a natural number equal to or greater than 2). Note that, the composite learners 120 (not illustrated) to 110 also includes two or more individual learners similarly to the composite learner 110. For example, the composite learner 110 includes individual learners 1i1 to 1ik (k is a natural number equal to or greater than 2).

Herein, the individual learner 111 and the like may be a weak learner. The weak learner is a learner in which estimation accuracy of a trained model included in the weak learner is superior to that in a case of randomly selecting, but it cannot be said that the estimation accuracy is high. Note that, in the following example, the individual learner 111 and the like will be described as including a trained model generated by a decision tree. However, a model included in the individual learner 111 and the like is not limited to the decision tree. For example, the individual learner 111 and the like may include a trained model generated by a method including at least one or more of a decision tree for performing multi-class classification or regression, a support vector machine, and a neural network.

Then, the composite learner 110 and the like include a trained model generated by ensemble learning using a plurality of weak learners as a plurality of individual learners. Therefore, the composite learner 110 and the like can be referred to as an ensemble learner. In other words, the composite learner 110 and the like include a computer program in which machine learning algorithm for ensemble learning is implemented, and a hyper parameter such as a setting value.

The storage apparatus 200 stores data sets 210 to 2m0 (m is a natural number equal to or greater than 1). The data set 210 and the like include a pair of a feature vector being multi-dimensional data and correct answer data (teacher data) of an estimated value. In particular, the data set 210 and the like are a set of a plurality of pairs of a feature vector and correct answer data. Each of the data set 210 and the like is one example of first and second data sets.

The information processing apparatus 300 is one example of the information processing apparatus 1 described above. The information processing apparatus 300 may be a computer apparatus that operates by a processor executing a program stored in a memory. The information processing apparatus 300 may be arranged in one physical computer apparatus, or may be arranged in two or more computer apparatuses in a distributed manner. The information processing apparatus 300 includes a model acquisition unit 31, a data acquisition unit 32, a model processing unit 33, a generation unit 34, an output unit 35, an operation acceptance unit 36, and an update unit 37. Note that, each or some of the model acquisition unit 31, the data acquisition unit 32, the model processing unit 33, the generation unit 34, the output unit 35, the operation acceptance unit 36, and the update unit 37 may be arranged in a plurality of computer apparatuses in a distributed manner. Note that, the output unit 35 is one example of the output unit 10 described above.

The model acquisition unit 31 acquires a composite learner including a model to be visualized. The model acquisition unit 31 may acquire, for example, by reading a composite learner specified by an operation by a user from among the composite learner 110 and the like in the storage apparatus 100.

The data acquisition unit 32 acquires a data set to be input to a composite learner. For example, the data acquisition unit 32 may acquire, for example, by reading a data set specified by an operation by a user from among the data set 210 and the like in the storage apparatus 200.

The model processing unit 33 analyzes an operation content and output information of each individual learner and a composite learner at a time in response to each piece of data of data set to be input is input to a model included in the composite learner to be visualized. For example, it can be said that the model processing unit 33 analyzes behavior of each weak learner at a time in response to data are input to a model. Alternatively, it can be said that the model processing unit 33 analyzes behavior of a composite learner being performed ensemble learning with respect to a predetermined data set. Note that, the model processing unit 33 may input the data set acquired by the data acquisition unit 32 to the composite learner acquired by the model acquisition unit 31, acquire composite output information from the composite learner, and acquire individual output information and configuration information from each individual learner. Then, the model processing unit 33 may analyze the individual output information and the configuration information of each individual learner, and thereby determine a relationship between the different individual learners.

In this case, the composite learner may input each piece of data of the data set input by the model processing unit 33 to each individual learner, and cause each individual learner to execute supervised learning by respective machine learning methods. In response, each individual learner trains a model by updating a parameter of the model by supervised learning. Note that, each individual learner may re-train the trained model. Further, some or all of the composite learner and each individual learner may be re-trained in a case where a change of the hyper parameter occurs according to an operation by a user.

The composite output information may be information acquired by aggregating the individual output information by the composite learner. Alternatively, in a case where all or some of the individual learners are connected to each other in series, the composite output information may be output information of an individual learner in a final stage. Note that, the model processing unit 33 may acquire the hyper parameter of the composite learner together with the composite output information from the composite learner, and analyze an operation content and the output information of the composite learner by using the composite output information and the hyper parameter.

Further, each individual learner may output, to the model processing unit 33, individual output information including a result of inputting the input data set to the trained model. The individual output information of each individual learner may include at least one or more of the number of pieces of data, an output result, and an error with respect to a target value, for each subspace of an input feature amount space in the individual learner to which the data set is input. The input feature amount space is, for example, distribution information and the like about each feature vector of the data set. Further, the subspace is a subset of input data and an estimated value. For example, in a case where a machine learning method is a decision tree, the subspace is equivalent to a leaf node. Therefore, the number of pieces of data for each subspace is equivalent to, for example, the number of pieces of data or the number of estimated values belonging to each leaf node. The output result is an execution result of the model. For example, the output result is a set of data or estimation values belonging to each subspace. The error with respect to the target value is, for example, a prediction error of data or an estimated value of an output result.

In addition, each individual learner may output configuration information such as a trained model to the model processing unit 33. The configuration information of each individual learner may include at least one or more of a result of dividing the input feature amount space into a subspace in the individual learner to which the data set is input, a distance between different subspaces, and a hyper parameter of each individual learner. Herein, for example, in a case where the machine learning method is a decision tree, the configuration information of each individual learner may be as follows. For example, the subspace may be a leaf of the decision tree. Then, for example, the result of dividing the input feature amount space into the subspace may include information of each node (element) of the decision tree, information (parent node ID or the like) indicating a connection relationship between the nodes, and the like. Further, for example, the distance between different subspaces may be a numerical value calculated from information indicating a hierarchy (position or depth) of the node. Alternatively, the distance between the different subspaces may be a set of degrees of similarity (a Euclidean distance, a Kullback-Leibler (KL) distance, and the like) in a feature amount space of samples included in each of the subspaces. Further, for example, the hyper parameter of each individual learner may include a threshold value (classification rule) of an internal node and the like.

Further, the relationship between the different individual learners may include at least one or more of a degree of similarity of each subspace in the different individual learner, and a degree of similarity of the hyper parameters of each individual learner. The degree of similarity of each subspace may be, for example, a degree of commonality of data belonging to the subspace. For example, in a case where the machine learning method is a decision tree, the degree of similarity of each subspace may be a degree of coincidence of data IDs belonging to a leaf node or the like. Further, the degree of similarity of different subspaces (leaves) may be, for example, a set of degrees of similarity (a Euclidean distance, a KL distance, and the like) in the feature amount space of the samples included in each of the subspaces. The degree of similarity of the hyper parameters of each individual learner is, for example, a difference value of setting values between a plurality of individual learners, but is not limited thereto.

The generation unit 34 generates graphic information summarizing the output information by each individual learner and the composite learner, the configuration information of each individual learner, and the relationship between the individual learners that are acquired and analyzed by the model processing unit 33. In other words, it can be said that the generation unit 34 converts the output information by each individual learner and the composite learner, the configuration information of each individual learner, and the relationship between the individual learners, into the graphic information indicating a characteristic of the composite learner. Alternatively, it can be said that the generation unit 34 converts the output information by each individual learner and the composite learner, the configuration information of each individual learner, and the relationship between the individual learners, into graphic information representing a characteristic of the individual learner, the relationship between the individual learners, and a difference between the data sets or the models.

Then, the generation unit 34 generates visualization information including the generated graphic information. Therefore, the visualization information may include numerical information or the like in addition to the graphic information. Herein, the generation unit 34 may generate the graphic information by summarizing various types of information as follows, for example.

For example, the generation unit 34 may summarize by converting the composite output information of the composite learner, the individual output information of each individual learner, the configuration information of each individual learner, and the relationship between the individual learners into a figure on a three-dimensional space. In other words, the graphic information may be information summarized by converting the composite output information of the composite learner, the individual output information of each individual learner, the configuration information of each individual learner, and the relationship between the individual learners into a figure on the three-dimensional space. As a result, four or more types (four dimensions) of information are compressed into three-dimensional information. Therefore, it is possible to extract a characteristic of the composite learner and the individual learner while reducing an amount of information, as compared with a list of numerical values of various types of information or an individual graph. Therefore, a user can easily survey the characteristic of the composite learner and the individual learner.

Moreover, for example, the generation unit 34 may summarize, for each individual learner, by arranging plane graphic information converted into a figure on a plane, based on the individual output information and the configuration information, in a layer shape in a vertical direction with respect to the plane. In other words, the graphic information may be information summarized, for each individual learner, by arranging the plane graphic information converted into a figure on a plane, based on the individual output information and the configuration information, in the layer shape in the vertical direction with respect to the plane. As a result, a user can easily grasp summary information of each of the plurality of different individual learners in comparison with each other.

Moreover, for example, the generation unit 34 may convert, for each individual learner, a plurality of elements included in the configuration information into visual information according to the number of pieces of data belonging to each element. In this case, the generation unit 34 may generate the plane graphic information by arranging the converted visual information in a manner based on the configuration information. In other words, the plane graphic information may be information in which, for each individual learner, visual information converted according to the number of pieces of data belonging to each element for a plurality of elements included in the configuration information is arranged in a manner based on the configuration information. Herein, “visual information converted according to the number of pieces of data belonging to each element” may be acquired by converting a magnitude, color, a shape, or the like of the visual information associated to the element into a different one according to the number of pieces of data belonging to the element. For example, the visual information of an element having a larger number of pieces of belonging data may be graphic information having a large size, an emphasized shape or color as compared to the visual information of an element having a smaller number of pieces of belonging data. Further, “arranging in a manner based on configuration information” may be that the generation unit 34 arranges visual information (graphic information) of each element on a plane according to a positional relationship, a distance, and the like of each element. For example, in a case where a distance between two specific elements is relatively short within specific configuration information, the generation unit 34 may arrange the visual information (graphic information) of the two specific elements relatively close to each other on a plane. As a result, a user can easily grasp summary information of each individual learner by looking at the summary information without using a numerical value or a graph.

Moreover, for example, the generation unit 34 may connect, by a line, elements to which data belongs in common between the plane graphic information in different individual learners. In other words, the graphic information may include a line in which elements to which the data belongs in common are connected to each other between the plane graphic information in different individual learners. As a result, a user can easily and visually grasp a relationship between specific elements among a plurality of different individual learners, a matter that data in the data set belong to which element in each individual learner, and the like.

The output unit 35 outputs, to a screen, the visualization information generated by the generation unit 34. For example, the output unit 35 displays the visualization information on a display apparatus within the information processing apparatus 300, or an external display apparatus connected to the information processing apparatus 300.

The operation acceptance unit 36 accepts an operation input from a user. For example, the operation acceptance unit 36 may accept, as an operation input, a switching operation between the visualization information and detailed information of the individual learner, an adjustment operation of any parameter, or the like.

The update unit 37 executes processing in response to an operation content accepted by the operation acceptance unit 36. Specifically, the update unit 37 may execute, in response to an operation input from a user, at least one of switching processing between the visualization information and the detailed information of the individual learner, adjustment processing of any parameter, and re-training processing of the composite learner. For example, in a case where the switching operation between the visualization information and the detailed information of the individual learner is accepted, the update unit 37 may switch between a display screen of the visualization information and a display screen of the detailed information of the individual learner, and cause the output unit 35 to output the display screen after the switching. Further, for example, in a case where the adjustment operation of any parameter is accepted, the update unit 37 may adjust (update) the corresponding parameter, and execute the re-training processing of the composite learner by using the parameter after the updating. Note that, the re-training processing of the composite learner may be executed by the model processing unit 33. In this case, the generation unit 34 generates visualization information again according to a result of the re-training processing. Then, the output unit 35 outputs the visualization information generated after the re-training. As a result, the adjustment operation of the parameter by a user is promptly reflected, and thus, the user can easily grasp a characteristic of the composite learner after the adjusting. Therefore, the user can easily perform fine adjustment on the parameter, and easily achieve appropriate tuning.

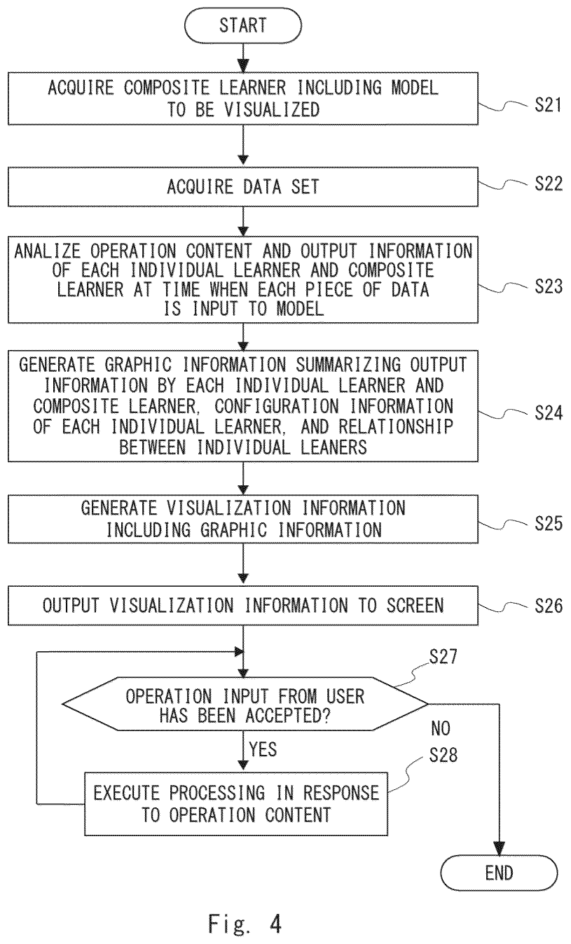

A flow of a visualization method will be described with reference to FIG. 4. First, the information processing apparatus 300 acquires a composite learner including a model to be visualized (S21). Next, the information processing apparatus 300 acquires a data set to be input to the composite learner (S22). Note that, the information processing apparatus 300 may replace execution order of steps S21 and S22, or may execute the steps in parallel.

Subsequently, the information processing apparatus 300 analyzes an operation content and output information of each individual learner and the composite learner at a time in response to each piece of data is input to the model (S23). Then, the information processing apparatus 300 generates graphic information summarizing the output information by each individual learner and the composite learner, configuration information of each individual learner, and a relationship between the individual learners (S24). Thereafter, the information processing apparatus 300 generates visualization information including the graphic information generated in step S24 (S25). Then, the information processing apparatus 300 outputs, to a screen, the visualization information generated in step S25 (S26).

Thereafter, the information processing apparatus 300 decides whether an operation input from a user has been accepted (S27). In a case where an operation input from a user is accepted within a certain period of time, the information processing apparatus 300 executes processing in response to an operation content (S28). Then, the information processing apparatus 300 executes step S27 again after the certain period of time has elapsed. In step S27, if the certain period of time has elapsed, or in a case where an end operation or the like has been accepted from a user, the information processing apparatus 300 ends the visualization method processing.

(Example of Visualization Information: Characteristic of Composite Learner, Characteristic of Individual Learner, and Relationship between Individual Learners)

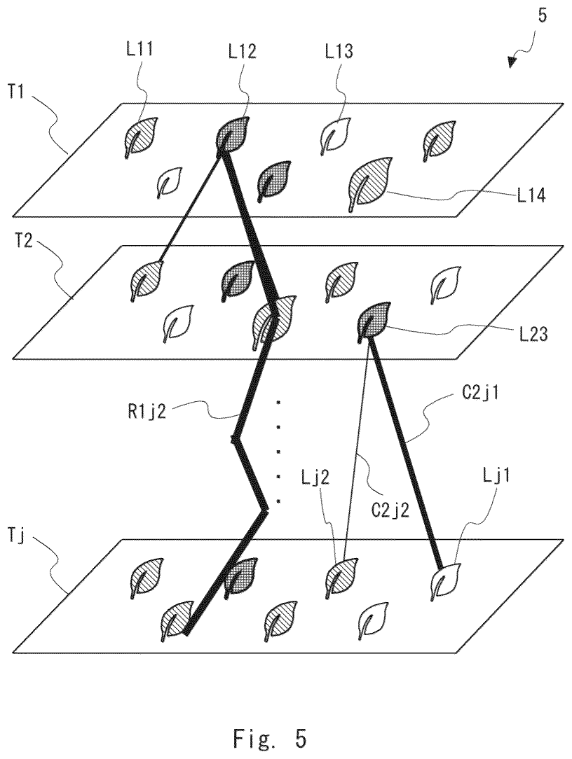

Herein, visualization information 5 will be described with reference to FIG. 5. The visualization information 5 is information visualized by using graphic information in order to visually survey behavior and a content of a composite learner and each individual learner to be configured. Further, the visualization information 5 indicates an example in which a model of the individual learner is a decision tree. However, the example of the model is not limited thereto, as described above.

The visualization information 5 includes individual characteristic information T1, T2, . . . , and Tj. Herein, each of the individual characteristic information T1 to Tj is one example of the plane graphic information converted into a figure on a plane, based on the individual output information and the configuration information, for each individual learner. Further, it can be said that the visualization information 5 is one example of the graphic information summarized by arranging the individual characteristic information T1 to Tj in a layer shape in the vertical direction with respect to the plane. For example, in the individual characteristic information T1 and the like, a configuration (hierarchical structure) of the decision tree itself, a connection relationship of a node, a threshold value of branching of the node, and data belonging to each leaf among the individual output information and the configuration information are not graphically formed. Note that, the individual characteristic information T1 and the like may be graphic information in which an outer frame is displayed and an inside is transmitted. Further, some or all of external shapes of the individual characteristic information T1 and the like may not be displayed. In other words, the individual characteristic information T1 and the like themselves need not be visualized as plane graphic information, and at least an element (leaf and the like) included in the same individual characteristic information may only be displayed on the same hierarchy.

In the individual characteristic information T1, leaves L11, L12, L13, L14, and the like are arranged. Each of the leaf L11 and the like is one example of visual information associated to the element included in the configuration information of the individual learner 111. Further, each of the leaf L11 and the like is one example of the subspace of the input feature amount space. The leaf L11 and the like are elements corresponding to leaf nodes among the elements included in the configuration information. In other words, the leaf L11 and the like indicate a set of data being a result of classification or estimation with respect to data set input to the individual learner 111. Note that, the visual information need not to be a schematic shape of a “leaf” as illustrated in FIG. 5, and may be another shape. The visual information associated to the element may be, for example, a circle, a double circle, a star, or a triangle, a square, or another polygon.

Then, each of the leaf L11 and the like is one example of visual information converted according to the number of pieces of data belonging to each element. Specifically, the leaf L11 and the like indicate an example of having a larger size as the number of pieces of data is larger. In FIG. 5, it is illustrated that the leaf L14 has the larger number of pieces of data than the leaves L11, L12, and L13. As a result, a user can easily visually grasp the number of pieces of data belonging to the element, based on the magnitude of visual information (graphic information) associated to the element, not based on a numerical value. Further, each of the leaf L11 and the like is also one example of visual information converted as different visual information according to a magnitude of the prediction error of data belonging to the element (leaf). For example, the leaf L11 and the like have different shading, colors, shapes, gradation, or the like depending on the magnitude of the prediction error of the data belonging to the leaf. Specifically, it is illustrated that the leaf L12 has a large prediction error as compared to the leaves L11, L13, and L14. Further, it is illustrated that the leaves L11 and L14 have equivalent (within a certain range) prediction errors. Moreover, it is illustrated that the leaf L13 has a small prediction error as compared to the leaves L11, L12 and L14.

Moreover, the individual characteristic information T1 is information in which the leaf L11 and the like are arranged in a manner based on the configuration information. Specifically, the leaves arranged in the individual characteristic information T1 are arranged in a positional relationship associated to a hierarchy of the element of the configuration information in the individual learner 111, a distance on the tree structure, a degree of similarity of data set, and the like. For example, the leaf L11 is arranged at a position where a relative distance to the leaf L12 is short and the relative distance to the leaf L14 is long. In other words, it can be said that the distance between the leaves visualizes that the degree of similarity between the subspaces on the feature amount space is close.

As described above, it can be said that the individual characteristic information T1 does not graphically form all of the elements, and is information in which, for example, an internal node is omitted. Further, it can be said that the individual characteristic information T1 is information in which a connection relationship between elements is also omitted. Further, the leaf L11 and the like do not display a value themselves of the belonging data (data being classified, an estimated value being estimated, and the like). In other words, the individual characteristic information T1 is information in which the internal node, the data itself, the connection relationship between the nodes, and the like are omitted from the configuration information and the individual output information of the individual learner 111. Further, in the individual characteristic information T1, each element is arranged in a relative positional relationship, based on the configuration information. Consequently, a user can easily visually recognize and grasp a summary of the individual learner 111 by the individual characteristic information T1. Further, a user can survey dispersion of a learning result and data, prediction accuracy, and the like in the individual learner 111 by the individual characteristic information T1.

Further, in FIG. 5, the individual characteristic information T1 to Tj are arranged side by side, and thus, a user can easily visually recognize and grasp the relationship between the different individual learners by surveying the individual characteristic information T1 to Tj.

Note that, in the example in FIG. 5, adjacent leaves are arranged with each other in an equal manner, but are merely one example. In other words, the positional relationship of each leaf arranged in the individual characteristic information T1 and the like may be a manner based on the configuration information. Further, in the example in FIG. 5, a magnitude of the leaf is not normalized among the different pieces of individual characteristic information, but the magnitude of the leaf may be normalized among the different pieces of individual characteristic information.

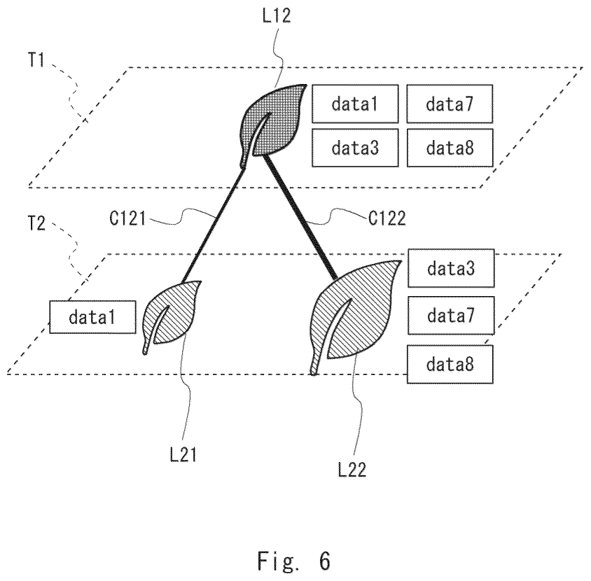

Herein, the relationship between the individual learners will be described with reference to FIG. 6. FIG. 6 illustrates commonality of data belonging between the elements by connection lines C121 and C122 for the individual characteristic information T1 and T2 arranged adjacent to each other in FIG. 5. Specifically, four pieces of data of data1, 3, 7, and 8 belong to the leaf L12 in the individual characteristic information T1. Further, data1 belong to a leaf L21 in the individual characteristic information T2. Furthermore, data3, 7, and 8 belong to a leaf L22 in the individual characteristic information T2. Therefore, it is illustrated that the leaf L12 of the individual characteristic information T1 and the leaf L21 of the individual characteristic information T2 are connected to each other by the connection line C121 because the data1 are common. Similarly, it is illustrated that the leaf L12 of the individual characteristic information T1 and the leaf L22 of the individual characteristic information T2 are connected to each other by the connection line C122 because the data3, 7, and 8 are common. Then, the leaf L22 has a large number of pieces of data in common with the leaf L12 as compared to the leaf L21, and thus the connection line C122 is displayed with emphasis than the connection line C121. FIG. 6 illustrates an example that the connection line C122 is emphasized by a line thicker than the connection line C121. Note that, a way of displaying emphasizing the connection line may be a difference in color, a difference in line type, or the like. Note that, it is illustrated that the leaf L22 has the large number of pieces of belonging data as compared to the leaf L21, and thus also has a large figure size.

In FIG. 5, an identification path R1j2 illustrates an example of a line that traces which element is classified or estimated in each individual learner with respect to specific data. For example, the information processing apparatus 300 may display the identification path R1j2 in the visualization information 5 in a case where an operation of displaying the identification path in the specific data in the data set is accepted from a user. As a result, a user can visually easily grasp which element is classified or estimated in each individual learner with respect to the specific data.

Further, as described above, the information processing apparatus 300 may display a screen associated to an operation in a case where a switching operation between the visualization information and the detailed information of the individual learner is accepted from a user. For example, the information processing apparatus 300 may display the detailed information of the individual learner associated to the selected individual characteristic information in a case where a selection operation of the individual characteristic information within the visualization information 5 is accepted from a user. Note that, the information processing apparatus 300 may display the visualization information 5 in a case where a switching operation from a display screen of the detailed information to a display screen of the visualization information 5 is accepted from a user. Note that, the information processing apparatus 300 may accept the switching operation, the selection operation, a change operation of a parameter, and the like from a user via any user interface.

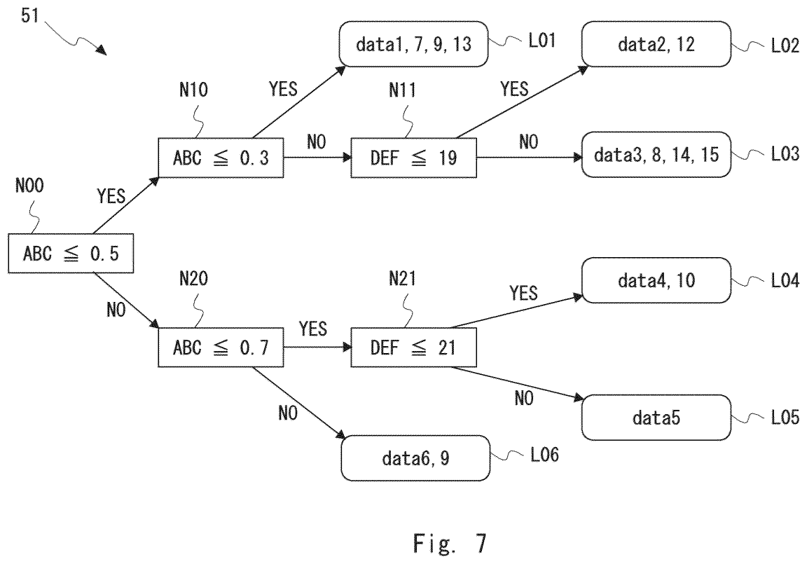

A display example of the detailed information of the configuration information of the individual learner will be described with reference to FIG. 7. A detailed information displaying screen 51 is an example of a decision tree, and displays a root node N00, internal nodes N10, N11, N20 and N21, and leaves L01 to L06. Specifically, it is illustrated that the root node N00 classifies each piece of data (a feature vector) of the input data set into the internal node N10 in a case where any feature amount ABC is equal to or less than 0.5 (YES), and classifies into the internal node N20 in other cases (N0). Hereinafter, similarly, it is illustrated that each piece of data is classified. For example, the leaf L01 indicates that data1, 7, 9, and 13 belongs to. Note that, the detailed information display screen 51 may be generated by using a known technique.

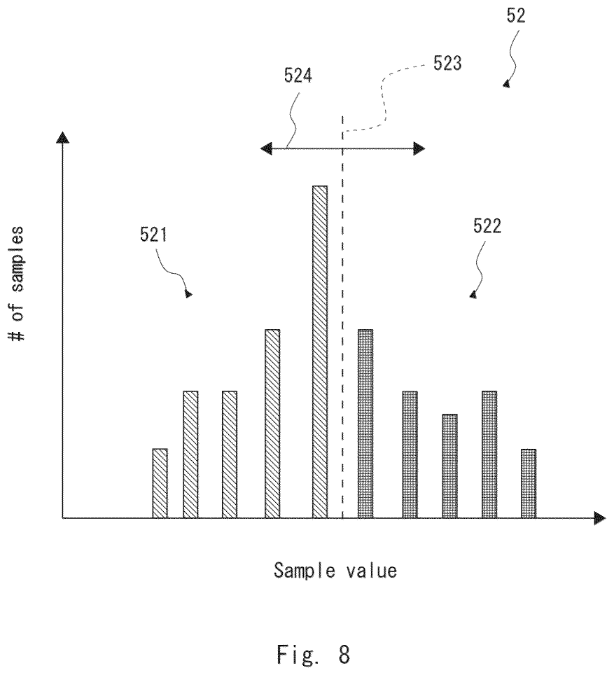

Subsequently, in the detailed information display screen 51, the information processing apparatus 300 may display a rule adjustment screen in a case where a selection operation of any internal node is accepted from a user. A display example of a rule adjustment screen 52 will be described with reference to FIG. 8. The rule adjustment screen 52 is an example of a screen displayed at a time if an element for classifying data by a rule (threshold value) is selected from among elements of a specific individual learner. In other words, the rule adjustment screen 52 is a screen that displays a branching rule (threshold value) of the internal node and a feature amount histogram of sample data included in the leaf, and accepts an adjustment operation of the rule. In the rule adjustment screen 52, a horizontal axis indicates a value of each piece of data of the input data set (a sample value, a specific feature amount of the feature vector), and a vertical axis indicates the number of pieces of data (the number of samples). The rule adjustment screen 52 indicates that each piece of data is classified into a sample data group 521 and a sample data group 522 at a threshold value 523. Then, adjustment 524 indicates that the threshold value 523 can be changed by a user. Thus, for example, the information processing apparatus 300 performs processing of changing a rule (threshold value) of a corresponding element (internal node) in a case where a movement operation of the threshold value 523 to a left and right is accepted from a user via any user interface. Specifically, as described above, the information processing apparatus 300 executes adjustment processing of any parameter, and executes re-training processing of the composite learner by using the parameter after the adjusting. Then, the information processing apparatus 300 may regenerate the visualization information 5 after the re-training, and display (update) the visualization information 5 after the regeneration. As a result, the adjustment operation of the parameter by a user is promptly reflected, and thus, the user can easily grasp a characteristic of the composite learner after adjusting.

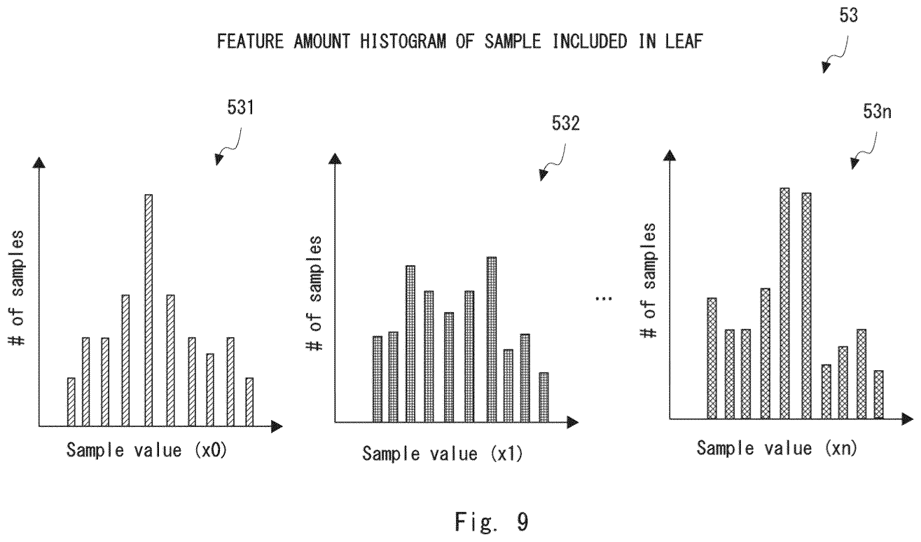

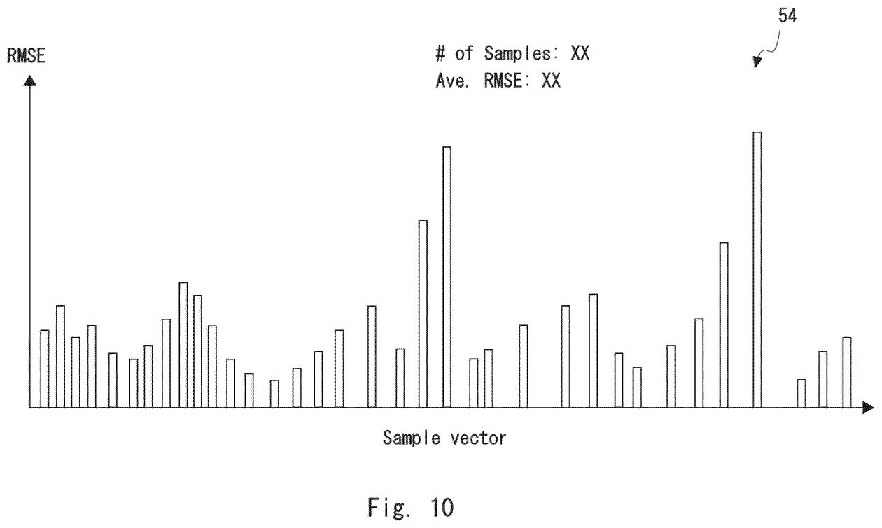

Further, in FIG. 5, the information processing apparatus 300 may display a feature amount histogram or a prediction error of the selected leaf in a case where a selection operation of a specific element (leaf) of specific individual characteristic information within the visualization information 5 is accepted from a user. A display example of a feature amount histogram of a sample included in a leaf will be described with reference to FIG. 9. A feature amount histogram group 53 includes feature amount histograms 531, 532, . . . , and 53n. For example, the feature amount histogram 531 indicates an x0-dimensional feature amount histogram in each feature vector of the input data set. Similarly, the feature amount histograms 532 to 53n indicate x1 to xn-1 dimensional feature amount histograms, respectively.

A display example of a prediction error of a sample included in a leaf will be described with reference to FIG. 10. In a prediction error distribution diagram 54, the horizontal axis is each piece of vector data of a feature amount vector (sample vector), and the vertical axis is a root mean squared error (RSME). Note that, each of FIGS. 9 and 10 is merely one example of a screen for displaying detailed information of an element (for example, a leaf node) being one piece of the configuration information of a specific individual learner included in the composite learner. Therefore, the detailed information of the element may be another display. Further, the information processing apparatus 300 may switch from the feature amount histogram group 53 or the prediction error distribution diagram 54 to a display screen of the visualization information 5 in response to an operation by a user via any user interface. Alternatively, the information processing apparatus 300 may display the feature amount histogram group 53 or the prediction error distribution diagram 54 together with the visualization information 5 in response to a user operation. As a result, a user can visually recognize behavior and a result of the composite learner efficiently and intuitively by optionally switching an overhead view display of the entire composite learner such as the visualization information 5 and the detailed display of the individual learner in an element unit.

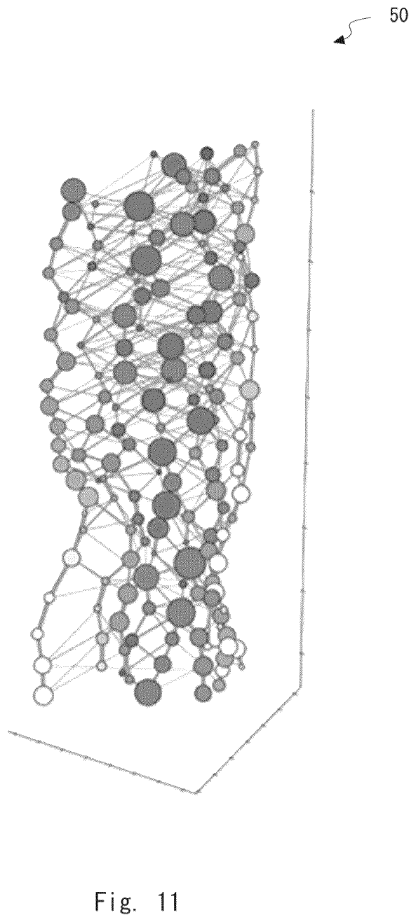

Subsequently, a display example of visualization information 50 will be described with reference to FIG. 11. The visualization information 50 is an example in which information generated, by using a gradient boosting decision tree, in a case where predetermined data set is input to a composite learner including a large number of individual learners is displayed on a three-dimensional space. The visualization information 50 is an example in which display of an external shape of the individual characteristic information is omitted. However, the visualization information 50 may display the external shape of the individual characteristic information similarly to the visualization information 5 in FIG. 5 described above.

Further, the example of the visualization information 50 is a gradient boosting method, and thus, it is schematically displayed that a plurality of individual learners are connected to each other in series. For example, an example in which information corresponding to individual characteristic information of each individual learner is equally arranged in a layer shape on the vertical axis (Z axis) is indicated. Note that, spacing of the layers is not limited to equal. The visualization information 50 is an example in which the number of pieces of data to which the element belonging to each layer belongs based on a magnitude is indicated, and a magnitude of the prediction error is indicated based on light and shade of the element. Further, elements to which common data belongs are connected to each other by a line between adjacent individual learners. Then, a thickness of the connection line indicates the number of pieces of data common among the elements. Note that, as described above, a way of displaying the number of pieces of data belonging to the element, a difference in the prediction error, and the relationship between the different individual learners is not limited thereto.

Further, in a case where a viewpoint change operation of the visualization information 50 is accepted from a user via any user interface, the information processing apparatus 300 may display on a screen by changing a display angle of a three-dimensional display. For example, the information processing apparatus 300 may display, in response to the viewpoint change operation, the visualization information 50 with an XY-axis plane in the horizontal direction on the screen and a Z-axis in the vertical direction on the screen. As a result, the individual characteristic information is displayed in an aligned manner in the vertical axis direction, and thus a user can more easily view the relationship of each individual learner. Note that, the connection line between the individual characteristic information may be connected between any individual learners, not limited to between the adjacent individual learners. Further, the information processing apparatus 300 may replace a position of the individual characteristic information and display the individual characteristic information in response to an operation of a user. Moreover, the information processing apparatus 300 may change a scale of the visualization information 50 in response to an operation of a user.

### (Example of Visualization Information: Difference Between Data Sets)

Subsequently, a case where a difference between data sets is displayed in the visualization information will be described. The information processing apparatus 300 may display, as visualization information, a difference in a training result of different data sets for the same composite learner. In other words, it is assumed that the information processing apparatus 300 generates, in advance, first graphic information summarizing, in a case where first data set is input to a first composite learner, composite output information, individual output information, configuration information of each individual learner, and a relationship between different individual learners. Thereafter, the information processing apparatus 300 generates second graphic information summarizing, in a case where second data set is input to the first composite learner, the composite output information output by the first composite learner, the individual output information output by each individual learner, the configuration information of each individual learner, and the relationship between different individual learners. Then, the information processing apparatus 300 may generate visualization information by further including difference information emphasizing a difference between the second graphic information and the first graphic information. Then, the information processing apparatus 300 displays the generated visualization information. In other words, first visualization information may further include difference information emphasizing a difference between the first graphic information and the second graphic information summarizing, in a case where the second data set is input to the first composite learner, the composite output information output by the first composite learner, the individual output information output by each individual learner, the configuration information of each individual learner, and the relationship between different individual learners.

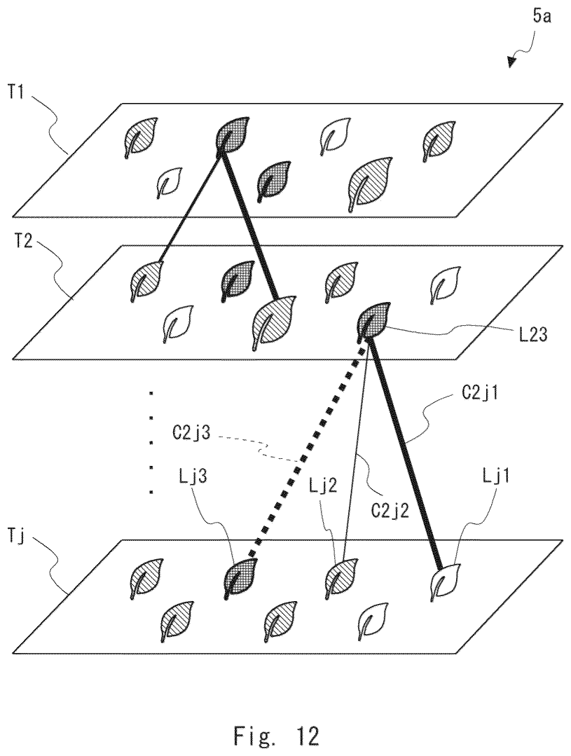

An example of a difference display between data sets in the visualization information will be described with reference to FIG. 12. In visualization information 5a, a connection line C2j3 between a leaf L23 of individual characteristic information T2 and a leaf Lj3 of individual characteristic information Tj is added as compared with the visualization information 5. Further, the connection line C2j3 is an example of a line displaying with emphasis the difference between the data sets. In other words, it is illustrated that the connection line C2j3 is displayed with emphasis than connection lines C2j1 and C2j2 to the leaf L23 having the same connection source. In this example, the connection line C2j3 is a thick broken line, but the difference from another connection line may be emphasized by color. For example, in a case where the connection lines C2j1 and C2j2 are black or light green, the connection line C2j3 may be a red line. Alternatively, the connection line C2j3 may be represented by a difference in line type. Further, the difference between the data sets is not limited to the difference between the connection lines, and may be a magnitude, a number, a distance between the elements, or the like of the elements (visual information).

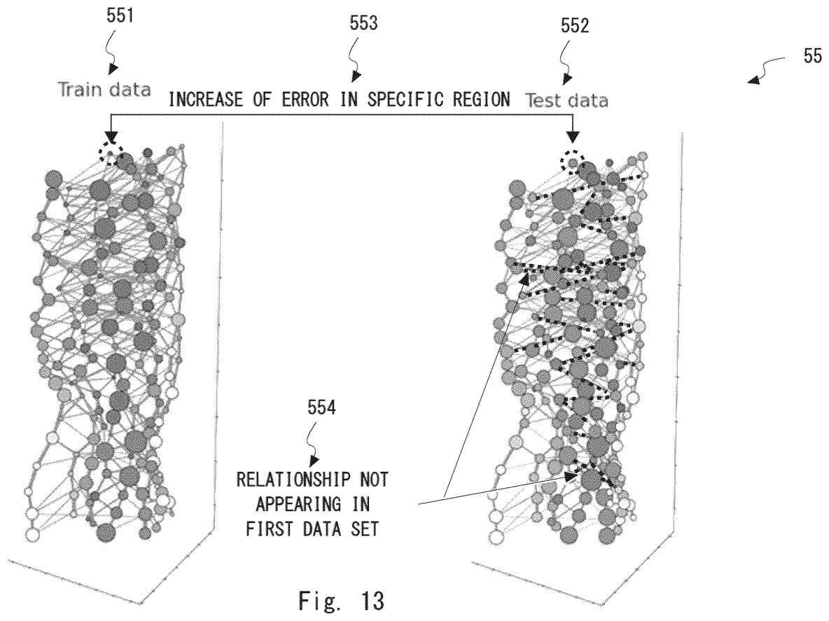

An example of a comparative display between different data sets in the same composite learner will be described with reference to FIG. 13. A comparative display screen 55 illustrates a comparative display example of a training result of the first data set (train data) and the second data set (test data). For example, as illustrated by increase 553, the number of pieces of data and an error are increased in visualization information 552 in a specific region (element) as compared to visualization information 551. Further, as illustrated by relationship addition 554, in the visualization information 552, connection lines are added to the elements having no connection line of the relationship in the visualization information 551.

Note that, the comparative display screen 55 displays the visualization information 551 and the visualization information 552 side by side, but the comparative display is not limited thereto. For example, the information processing apparatus 300 may display the comparative display screen 55 in a case where a selection operation of any plurality of data sets is accepted from a user, in a state where the same composite learner has been trained by a plurality of data sets and visualization information has been generated.

As a result, a user can easily visually recognize and grasp a difference between the training result of each of the first and second data sets in the same composite learner. For example, a user can easily grasp a region having a large prediction error. Therefore, a user can easily estimate an analysis and an examination of the composite learner. For example, it is easy to detect a portion of overfitting. Therefore, even if it is a non-expert in machine learning, a difference between data sets can be easily grasped. Then, a non-expert can accurately inquire an expert in the machine learning and provide appropriate information.

(Example of Visualization Information: Difference between Composite Learners)

Note that, the information processing apparatus 300 may display, as visualization information, a difference in training result of the same data set for different composite learners. In other words, it is assumed that the information processing apparatus 300 generates, in advance, first graphic information summarizing, in a case where first data set is input to a first composite learner, composite output information, individual output information, configuration information of each individual learner, and a relationship between different individual learners. Thereafter, the information processing apparatus 300 generates third graphic information summarizing, in a case where the first data set is input to a second composite learner being different from the first composite learner, the composite output information output by the second composite learner, the individual output information output by each individual learner, the configuration information of each individual learner, and the relationship between different individual learners. Then, the information processing apparatus 300 may generate visualization information by further including difference information emphasizing a difference between the third graphic information and the first graphic information. Then, the information processing apparatus 300 displays the generated visualization information. In other words, first visualization information may further include difference information emphasizing a difference between the first graphic information and the third graphic information summarizing, in a case where the first data set is input to the second composite learner being different from the first composite learner, the composite output information output by the second composite learner, the individual output information output by each individual learner, the configuration information of each individual learner, and the relationship between the different individual learners. Note that, a way of displaying the difference between the composite learners may be similar to the way of displaying the difference between the data sets described above.

As described above, by the visualization method according to the present disclosure, in the machine learning method (ensemble method) in which a plurality of individual learners are combined, it is possible to enhance explanatory property of a trained model, interpretation of a result, and maintenance. In other words, the visualization information makes it possible to survey and easily visually recognize an internal configuration of the individual learner and the composite learner, validity of an output, an individual training result, and overall training result. In particular, the entire ensemble learner is visualized in an overhead manner by focusing on a relationship between the weak learners. Therefore, it is possible to survey and visually grasp unique behavior of a model.

Note that, a technique according to Japanese Unexamined Patent Application Publication No. 2022-067429 graphically displays a single indicator, and displays a list for each indicator. Therefore, in a case where the number of individual identifiers or types of indicators are equal to or larger than a certain number, it is difficult to display a list, and it is difficult to grasp an entire image. Further, a relationship or a role between individual identifiers are intuitively difficult to understand.

In contrast, by the visualization method according to the present disclosure, even in a case where the number of individual identifiers or types of the indicators are equal to or larger than a certain number, since converting into summarized graphic information, the overall image of the composite learner and the plurality of individual learners can be surveyed and easily grasped.

Further, with regard to the configuration and the like of the composite learner, above-described intuitive rule adjustment and immediate re-training, and updating and displaying of the visualization information based on a re-training result enable appropriate setting change (fine-tuning) to be easily performed even by a non-expert in AI or machine learning. Further, a user can grasp an influence of the setting change on each of the individual learners in a short time. Further, a non-expert can detect a suspicious point at an early stage, and can easily consult with an expert (such as a data scientist). Furthermore, the visualization information can be used as a clue for a factor analysis of an error during actual operation of a trained model group of the composite learner.

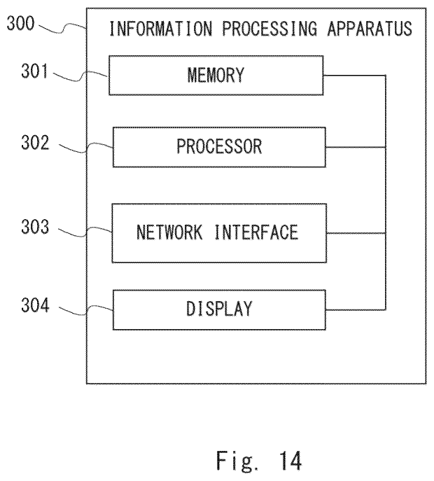

One example of a hardware configuration of the information processing apparatus 300 will be described with reference to FIG. 14. The information processing apparatus 300 includes a memory 301, a processor 302, a network interface 303, and a display 304. Note that, as described above, the display 304 may be an external apparatus of the information processing apparatus 300.

The memory 301 is configured by a combination of a volatile memory and a non-volatile memory. The volatile memory is, for example, a volatile storage apparatus such as a random access memory (RAM), and is a storage region for temporarily storing information at a time during the processor 302 operates. The non-volatile memory is, for example, a non-volatile storage apparatus such as a hard disk or a flash memory. The memory 301 stores at least a computer program on which visualization processing of the information processing apparatus 300 according to the present disclosure is implemented. Note that, the memory 301 may include a storage arranged apart from the processor 302. In this case, the processor 302 may access the memory 301 via a not-illustrated input/output (I/O) interface.

The processor 302 is a control apparatus that controls each configuration of the information processing apparatus 300. The processor 302 reads and executes software (a computer program) from the memory 301. As a result, the processor 302 achieves functions of the model acquisition unit 31, the data acquisition unit 32, the model processing unit 33, the generation unit 34, the output unit 35, the operation acceptance unit 36, and the update unit 37. In other words, the processor 302 performs visualization processing according to the present disclosure. The processor 302 may be, for example, a microprocessor, a multi processing unit (MPU), or a central processing unit (CPU). Further, the processor 302 may include a plurality of processors.

The network interface 303 may be used for communicating with a network node. The network interface 303 may include, for example, a network interface card (NIC) compliant with IEEE 802.3 series. IEEE represents Institute of Electrical and Electronics Engineers.

The display 304 is a display apparatus that displays information instructed by the processor 302. The display 304 is, for example, a screen such as a liquid crystal display or an organic electro-luminescence (EL) display.

### Another Example Embodiment

Note that, a visualization method according to the present disclosure is applicable to any of a regression problem and a classification problem. In other words, the above-described output unit 35 outputs, as first visualization information, a result of applying a composite learner to any one of a predetermined classification problem and regression problem.

Note that, the above-described example embodiment is targeted for boosting among ensemble learning methods, in which decision trees of (a weak learner) are connected in series. However, the present disclosure is also applicable to other learning methods (bagging and stacking).

Note that, in a case of bagging, arrangement order in the decision tree (individual characteristic information) may be optional. Then, an information processing apparatus 300 may be capable of changing the arrangement order of the individual characteristic information in response to a specification operation by a user. Further, in a case of stacking, there may be branching or aggregation of the decision tree, and thus, another display may be possible.

Note that, the above-described example embodiment has been described as a hardware configuration, but is not limited thereto. The present disclosure can also be achieved by causing a CPU to execute a computer program.

In the examples described above, a program includes instructions (or a software code) that, if loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Then, each example embodiment can be combined with other example embodiments as appropriate.

Each drawing is merely illustrative of one or more example embodiments. Each drawing may be associated with one or more other example embodiments, rather than only one particular example embodiment. As those skilled in the art will appreciate, various features or steps described with reference to any one of the figures may be combined with a feature or a step illustrated in one or more other figures, for example, in order to generate an example embodiment not explicitly illustrated or described. All of the features or steps illustrated in any one of the figures in order to describe the example embodiments are not necessarily essential, and some features or steps may be omitted. Order of the steps described in any of the figures may be changed as appropriate.

An example advantage according to the above-described example embodiment is to provide an information processing apparatus, a visualization method, and a visualization program for easily comprehensively visually recognize a characteristic of a composite learner including a plurality of learners.

Some or all of the above-described example embodiments may be described as the following supplementary notes, but are not limited thereto.

### (Supplementary Note A1)

An information processing apparatus including:
an output means for outputting first visualization information including first graphic information summarizing, in a case where a first data set is input to a first composite learner including a plurality of individual learners, composite output information output by the first composite learner, individual output information output by each individual learner, configuration information of each individual learner, and a relationship between different individual learners.

### (Supplementary Note A2)

The information processing apparatus according to supplementary note A1, wherein the first graphic information is information summarized by converting the composite output information, the individual output information, the configuration information, and the relationship into a figure on a three-dimensional space.

### (Supplementary Note A3)

The information processing apparatus according to supplementary note A2, wherein the first graphic information is information summarized by arranging, for each of the individual learners, plane graphic information converted into a figure on a plane, based on the individual output information and the configuration information, in a layer shape in a vertical direction with respect to the plane.

### (Supplementary Note A4)

The information processing apparatus according to supplementary note A3, wherein the plane graphic information is information in which visual information converted according to the number of pieces of data belonging to each element for a plurality of elements included in the configuration information is arranged, for each of the individual learners, in a manner based on the configuration information.

### (Supplementary Note A5)

The information processing apparatus according to supplementary note A4, wherein the first graphic information includes a line in which elements to which data belongs in common are connected to each other among the plane graphic information in different individual learners.

### (Supplementary Note A6)

The information processing apparatus according to any one of supplementary notes A1 to A5, wherein the output unit outputs, as the first visualization information, a result acquired by applying the first composite learner to any one of a predetermined classification problem and a predetermined regression problem.

### (Supplementary Note A7)

The information processing apparatus according to any one of supplementary notes A1 to A6, wherein the first visualization information further includes difference information emphasizing a difference between the first graphic information, and second graphic information summarizing, in a case where a second data set is input to the first composite learner, composite output information output by the first composite learner, individual output information output by each individual learner, configuration information of each individual learner, and a relationship between different individual learners.

### (Supplementary Note A8)

The information processing apparatus according to any one of supplementary notes A1 to A6, wherein the first visualization information further includes difference information emphasizing a difference between the first graphic information, and third graphic information summarizing, in a case where a first data set is input to a second composite learner different from the first composite learner, composite output information output by the second composite learner, individual output information output by each individual learner, configuration information of each individual learner, and a relationship between different individual learners.

### (Supplementary Note A9)

The information processing apparatus according to any one of supplementary notes A1 to A8, wherein the composite learner includes a trained model generated by ensemble learning using a plurality of weak learners as the plurality of individual learners.

### (Supplementary Note A10)

The information processing apparatus according to any one of supplementary notes A1 to A9, wherein the configuration information includes at least one or more of a result of dividing an input feature amount space into a subspace in the individual learner to which the first data set is input, a distance between different subspaces, and a hyper parameter of each individual learner.

### (Supplementary Note A11)

The information processing apparatus according to any one of supplementary notes A1 to A10, wherein the individual output information includes at least one or more of the number of pieces of data, an output result, and an error with respect to a target value for each subspace of an input feature amount space in the individual learner to which the first data set is input.

### (Supplementary Note A12)

The information processing apparatus according to any one of supplementary notes A1 to A11, wherein the relationship includes at least one or more of each subspace in a different individual learner, and a degree of similarity of a hyper parameter of each individual learner.

### (Supplementary Note A13)

The information processing apparatus according to any one of supplementary notes A1 to A12, wherein the individual learner includes a trained model generated by a method including at least one or more of a decision tree for performing multi-class classification or regression, a support vector machine, and a neural network.

### (Supplementary Note A14)

The information processing apparatus according to any one of supplementary notes A1 to A13, wherein the information processing apparatus executes, in response to an operation input from a user, at least one of switching processing between the first visualization information and detailed information of the individual learner, adjustment processing of any parameter, and re-training processing of a composite learner.

### (Supplementary Note B1)

A visualization method including,
by a computer:
acquiring a first data set; and
outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

### (Supplementary Note C1)

A visualization program causing a computer to execute:
processing of acquiring a first data set; and
processing of outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

Some or all of elements (e.g., a configuration and a function) described in Supplementary notes A2 to A14 dependent on Supplementary note A1 (e.g., an apparatus} may also be dependent on Supplementary notes B1 (e.g., a method) and C1 (e.g., a program) in dependency similar to that of Supplementary notes A2 to A14. Some or all of elements described in any of Supplementary notes may be applied to various types of hardware, software, a recording means for recording software, a system, and a method.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An information processing apparatus comprising:
at least one storage apparatus configured to store instructions; and
at least one processor configured to execute the instructions to:
output first visualization information including first graphic information summarizing, in a case where a first data set is input to a first composite learner including a plurality of individual learners, composite output information output by the first composite learner, individual output information output by each individual learner, configuration information of each individual learner, and a relationship between different individual learners.

2. The information processing apparatus according to claim 1, wherein the first graphic information is information summarized by converting the composite output information, the individual output information, the configuration information, and the relationship into a figure on a three-dimensional space.

3. The information processing apparatus according to claim 2, wherein the first graphic information is information summarized by arranging, for each of the individual learners, plane graphic information converted into a figure on a plane, based on the individual output information and the configuration information, in a layer shape in a vertical direction with respect to the plane.

4. The information processing apparatus according to claim 3, wherein the plane graphic information is information in which visual information converted according to the number of pieces of data belonging to each element for a plurality of elements included in the configuration information is arranged, for each of the individual learners, in a manner based on the configuration information.

5. The information processing apparatus according to claim 4, wherein the first graphic information includes a line in which elements to which data belongs in common are connected to each other among the plane graphic information in different individual learners.

6. The information processing apparatus according to claim 1, wherein the at least one processor is further configured to execute the instructions to:
output, as the first visualization information, a result acquired by applying the first composite learner to any one of a predetermined classification problem and a predetermined regression problem.

7. The information processing apparatus according to claim 1, wherein the first visualization information further includes difference information emphasizing a difference between the first graphic information, and second graphic information summarizing, in a case where a second data set is input to the first composite learner, composite output information output by the first composite learner, individual output information output by each individual learner, configuration information of each individual learner, and a relationship between different individual learners.

8. The information processing apparatus according to claim 1, wherein the first visualization information further includes difference information emphasizing a difference between the first graphic information, and third graphic information summarizing, in a case where a first data set is input to a second composite learner different from the first composite learner, composite output information output by the second composite learner, individual output information output by each individual learner, configuration information of each individual learner, and a relationship between different individual learners.

9. The information processing apparatus according to claim 1, wherein the composite learner includes a trained model generated by ensemble learning using a plurality of weak learners as the plurality of individual learners.

10. The information processing apparatus according to claim 1, wherein the configuration information includes at least one or more of a result of dividing an input feature amount space into a subspace in the individual learner to which the first data set is input, a distance between different subspaces, and a hyper parameter of each individual learner.

11. The information processing apparatus according to claim 1, wherein the individual output information includes at least one or more of the number of pieces of data, an output result, and an error with respect to a target value for each subspace of an input feature amount space in the individual learner to which the first data set is input.

12. The information processing apparatus according to claim 1, wherein the relationship includes at least one or more of each subspace in a different individual learner, and a degree of similarity of a hyper parameter of each individual learner.

13. The information processing apparatus according to claim 1, wherein the individual learner includes a trained model generated by a method including at least one or more of a decision tree for performing multi-class classification or regression, a support vector machine, and a neural network.

14. The information processing apparatus according to claim 1, wherein the at least one processor is further configured to execute the instructions to:
execute, in response to an operation input from a user, at least one of switching processing between the first visualization information and detailed information of the individual learner, adjustment processing of any parameter, and re-training processing of a composite learner.

15. A visualization method comprising,
by a computer:
acquiring a first data set; and
outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

16. The visualization method according to claim 15, wherein the first graphic information is information summarized by converting the composite output information, the individual output information, the configuration information, and the relationship into a figure on a three-dimensional space.

17. The visualization method according to claim 16, wherein the first graphic information is information summarized by arranging, for each of the individual learners, plane graphic information converted into a figure on a plane, based on the individual output information and the configuration information, in a layer shape in a vertical direction with respect to the plane.

18. A non-transitory computer-readable medium storing a visualization program causing a computer to execute:
processing of acquiring a first data set; and
processing of outputting first visualization information including first graphic information summarizing, in a case where the first data set is input to a first composite learner including a plurality of individual learners, composite output information output by the first composite learner, individual output information output by each individual learner, configuration information of each individual learner, and a relationship between different individual learners.

19. The non-transitory computer-readable medium according to claim 18, wherein the first graphic information is information summarized by converting the composite output information, the individual output information, the configuration information, and the relationship into a figure on a three-dimensional space.

20. The non-transitory computer-readable medium according to claim 19, wherein the first graphic information is information summarized by arranging, for each of the individual learners, plane graphic information converted into a figure on a plane, based on the individual output information and the configuration information, in a layer shape in a vertical direction with respect to the plane.
